(19) United States
(12) Patent Application Publication
(10) Pub. No.: US 2021/0306924 A1
(43) Pub. Date: Sep. 30, 2021

(54) ELECTRONIC APPARATUS AND COMMUNICATION SYSTEM

(71) Applicant: SEIKO EPSON CORPORATION, SHINJUKU-KU (JP)

(72) Inventor: Kota NISHIDA, Shiojiri-shi (JP)

(21) Appl. No.: 17/211,394

(22) Filed: Mar. 24, 2021

(30) Foreign Application Priority Data
Mar. 27, 2020 (JP) 2020-056949

(51) Int. Cl. H04W 36/18; H04W 4/80

(52) U.S. Cl. CPC H04W 36/18; H04W 4/80

(57) ABSTRACT

An electronic apparatus includes a wireless communication section configured to perform first wireless communication through an access point and second wireless communication, which is short-range wireless communication, and a processing section configured to perform communication control for the wireless communication section. When a connection destination by the first wireless communication is switched from a first access point to a second access point, the processing section performs transmission processing for transmitting connection information for connecting to the second access point to another electronic apparatus using the second wireless communication.

The present application is based on, and claims priority from JP Application Serial Number 2020-056949, filed Mar. 27, 2020, the disclosure of which is hereby incorporated by reference herein in its entirety.

### BACKGROUND

### 1. Technical Field

The present disclosure relates to an electronic apparatus and a communication system.

### 2. Related Art

In recent years, electronic apparatuses having a function of connecting to a network have been increasing. Since a plurality of electronic apparatuses are connected to one access point, it is necessary to perform resetting of the plurality of electronic apparatuses when replacing the access point.

JP-A-2017-200136 (Patent Literature 1) discloses a method of, when an access point is changed in a situation in which two apparatuses are connected via the access point, continuing a session established between the two apparatuses.

In the method disclosed in Patent Literature 1, in a state in which a session via an access point before replacement is established, information for connecting to a new access point is transmitted from one apparatus to the other apparatus based on user operation. Accordingly, when the access point before replacement cannot be used because of a cause such as a failure, transmission and reception of connection information cannot be performed.

### SUMMARY

An aspect of the present disclosure relates to an electronic apparatus including: a wireless communication section configured to perform first wireless communication through an external access point and second wireless communication, which is short-range wireless communication; and a processing section configured to perform communication control for the wireless communication section. When a connection destination by the first wireless communication is switched from a first access point to a second access point, the processing section performs transmission processing for transmitting connection information for connecting to the second access point to another electronic apparatus using the second wireless communication.

Another aspect of the present disclosure relates to an electronic apparatus including: a wireless communication section configured to perform first wireless communication through an external access point and second wireless communication, which is short-range wireless communication; and a processing section configured to perform communication control for the wireless communication section. The processing section shifts to a connection standby state when connection to a first access point by the first wireless communication is cut off and, in the connection standby state, when receiving, using the second wireless communication, from another electronic apparatus, connection information for connecting to a second access point, performs connection processing to the second access point by the first wireless communication using the connection information.

Still another aspect of the present disclosure relates to a communication system including: a first electronic apparatus configured to perform first wireless communication for performing wireless communication through an external access point and second wireless communication, which is short-range wireless communication; and a second electronic apparatus configured to perform the first wireless communication and the second wireless communication. When a connection destination by the first wireless communication is switched from a first access point to a second access point, the first electronic apparatus performs transmission processing for transmitting connection information for connecting to the second access point to the second electronic apparatus using the second wireless communication. The second electronic apparatus shifts to a connection standby state when connection to the first access point by the first wireless communication is cut off and performs reception processing for receiving, using the second wireless communication, from the first electronic apparatus, the connection information for connecting to the second access point.

### BRIEF DESCRIPTION OF THE DRAWINGS

FIG. 1 is a diagram for explaining connection between an electronic apparatus and an access point.

FIG. 2 is a configuration example of the electronic apparatus.

FIG. 3 is a diagram for explaining a method in an embodiment.

FIG. 4 is a diagram for explaining the method in the embodiment.

FIG. 5 is a flowchart for explaining processing during connection to a first access point.

FIG. 6 is an example of list information.

FIG. 7 is a flowchart for explaining processing performed when the connection to the first access point is cut off.

FIG. 8 is a diagram for explaining a flow of connection processing to a second access point.

FIG. 9 is a diagram for explaining a method in the embodiment by a communication system including a printer and a terminal device.

FIG. 10 is a diagram for explaining the method in the embodiment by the communication system including the printer and the terminal device.

### DESCRIPTION OF EXEMPLARY EMBODIMENTS

An embodiment is explained below. The embodiment explained below does not unduly limit contents described in the appended claims. Not all of components explained in this embodiment are always essential constituent elements.

### 1. System Configuration and Overview of Processing

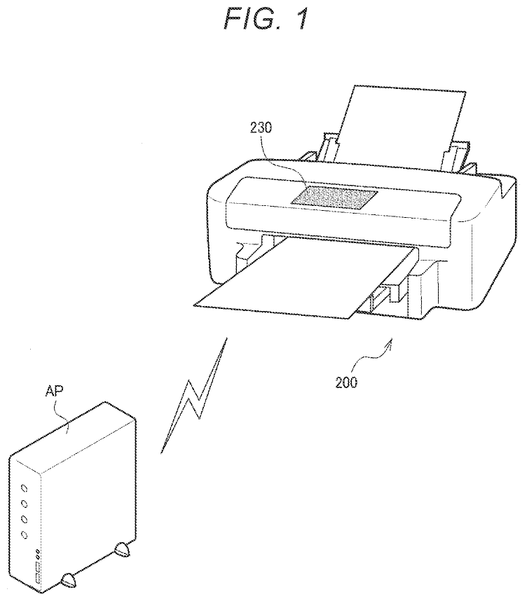

FIG. 1 is a diagram schematically showing an example of a system configuration in this embodiment. As shown in FIG. 1, an electronic apparatus 200 in this embodiment is connected to an access point AP. The access point AP is, for example, a wireless router having a router function.

The electronic apparatus 200 is, for example, a printer. Alternatively, the electronic apparatus 200 may be a scanner, a facsimile apparatus, or a copy machine. The electronic apparatus 200 may be a multifunction peripheral (MFP) having a plurality of functions. A multifunction peripheral having a printing function is also an example of the printer. Alternatively, the electronic apparatus 200 may be a projector, a head-mounted display apparatus, a wearable apparatus, a biological information measurement apparatus, a robot, a video apparatus, a portable information terminal, a physical quantity measurement apparatus, or the like. The biological information measurement apparatus is a pulsimeter, a pedometer, an activity meter, or the like. The video apparatus is a camera or the like. The portable information terminal is a smartphone, a portable game machine, or the like.

The electronic apparatus 200 performs communication by radio with the access point AP. The wireless communication is communication using a Wi-Fi scheme in a narrow sense. The Wi-Fi scheme is, for example, a wireless communication scheme based on an IEEE (Institute of Electrical and Electronics Engineers) 802.11 standard and a standard equivalent to the IEEE802.11 standard.

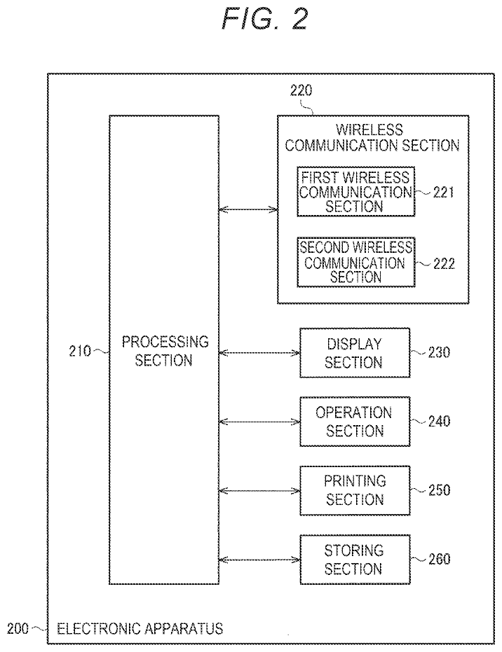

FIG. 2 is a block diagram showing an example of the configuration of the electronic apparatus 200. FIG. 2 shows the electronic apparatus 200 having a printing function. In the following explanation, an example in which the electronic apparatus 200 is a printer is explained as appropriate. However, as explained above, the electronic apparatus 200 can be extended to an apparatus other than the printer. The electronic apparatus 200 includes a processing section 210, a wireless communication section 220, a display section 230, an operation section 240, a printing section 250, and a storing section 260.

The processing section 210 performs control of the sections of the electronic apparatus 200. The sections of the electronic apparatus 200 are, for example, the wireless communication section 220, the storing section 260, and the printing section 250. The processing section 210 is specifically a processor or a controller. For example, the processing section 210 can include a plurality of CPUs such as a main CPU and a sub-CPU. The main CPU performs control of the sections of the electronic apparatus 200 and overall control of the electronic apparatus 200. The sub-CPU is, for example, a CPU that performs communication control for the wireless communication section 220. Alternatively, when the electronic apparatus 200 is the printer, a CPU that performs various kinds of processing about printing may be further provided.

The processing section 210 in this embodiment is configured by hardware explained below. The hardware can include at least one of a circuit that processes a digital signal and a circuit that processes an analog signal. For example, the hardware can be configured by one or a plurality of circuit devices or one or a plurality of circuit elements mounted on a circuit board. The one or the plurality of circuit devices are, for example, ICs (Integrated Circuits) or FPGAs (field-programmable gate arrays). The one or the plurality of circuit elements are, for example, resistors or capacitors.

The processing section 210 may be realized by a processor explained below. The electronic apparatus 200 in this embodiment includes a memory that stores information and a processor that operates based on the information stored in the memory. The information is, for example, programs and various data. The processor includes hardware. As the processor, various processors such as a CPU (Central Processing Unit), a GPU (Graphics Processing Unit), and a DSP (Digital Signal Processor) can be used. The memory may be a semiconductor memory such as an SRAM (Static Random Access Memory) or a DRAM (Dynamic Random Access Memory), may be a register, may be a magnetic storage device such as a hard disk device, or may be an optical storage device such as an optical disk device. For example, the memory stores an instruction readable by a computer. The processor executes the instruction, whereby a function of the processing section 210 is realized as processing. The instruction may be an instruction of an instruction set configuring a program or may be an instruction for instructing a hardware circuit of the processor to perform operation. Further, the entire or a part of the processing section 210 may be realized by cloud computing.

The wireless communication section 220 includes a first wireless communication section 221 and a second wireless communication section 222. The first wireless communication section 221 performs wireless communication conforming to the Wi-Fi scheme. The second wireless communication section 222 performs short-range wireless communication. The short-range wireless communication is, for example, wireless communication conforming to a Bluetooth (registered trademark) scheme. The Bluetooth scheme is, for example, a wireless communication scheme based on an IEEE802.15.1 standard and a standard equivalent to the IEEE802.15.1 standard. The wireless communication conforming to the Bluetooth scheme may be, for example, wireless communication conforming to a BLE (Bluetooth Low Energy). However, the short-range wireless communication is not limited to the Bluetooth scheme and other schemes may be used.

The wireless communication section 220 is realized by at least one wireless communication device. The wireless communication device may be called wireless communication chip as well. For example, the wireless communication section 220 may include a first wireless communication device that executes the wireless communication conforming to the Wi-Fi scheme and a second wireless communication device that executes the wireless communication conforming to the Bluetooth scheme. In other words, the first wireless communication section 221 and the second wireless communication section 222 may be respectively realized by different wireless communication devices. Alternatively, the first wireless communication section 221 and the second wireless communication section 222 may be realized by a common wireless communication device. For example, one wireless communication device executes the wireless communication conforming to the Wi-Fi scheme and the wireless communication conforming to the Bluetooth scheme in a time division manner, whereby the first wireless communication section 221 and the second wireless communication section 222 may be realized.

The display section 230 is configured by a display or the like that displays various kinds of information to a user. The operation section 240 is configured by buttons or the like that receive input operation from the user. The display section 230 and the operation section 240 may be integrally configured by, for example, a touch panel.

The printing section 250 includes a printing engine. The printing engine is a mechanical component that executes printing of an image on a printing medium. The printing engine includes, for example, a conveying mechanism, an ejection head of an inkjet scheme, and a driving mechanism for a carriage including the ejection head. The printing engine ejects, from the ejection head, ink to a printing medium conveyed by the conveying mechanism to print an image on the printing medium. The printing medium may be paper, may be cloth, or may be another medium. A specific configuration of the printing engine is not limited to the configuration illustrated above. The printing engine may perform printing with toner in an electrophotographic scheme.

The storing section 260 stores various kinds of information such as data and programs. The processing section 210 and the wireless communication section 220 operate using, for example, the storing section 260 as a work area. The storing section 260 may be a semiconductor memory such as a RAM or a DRAM, may be a register, may be a magnetic storage device, or may be an optical storage device. The storing section 260 may store data transmitted by wireless communication from an information processing device connected to the access point AP. The data is, for example, data used for printing in the printing section 250.

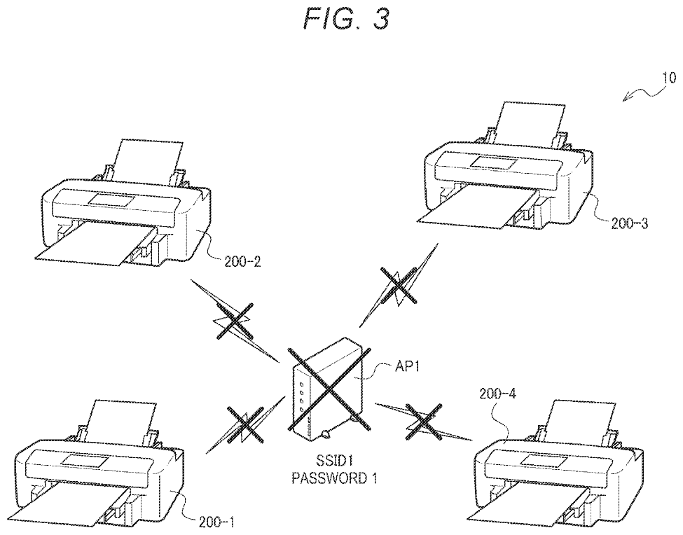

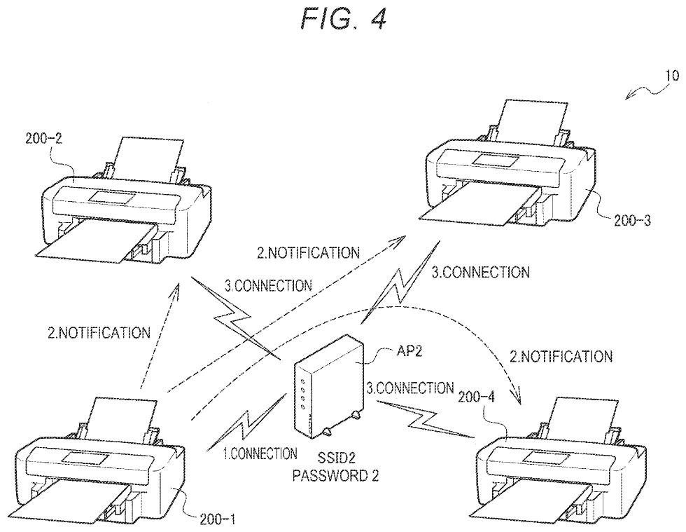

FIGS. 3 and 4 are diagrams for explaining an overview of processing in this embodiment. FIG. 3 is a diagram showing a state before replacement. A plurality of electronic apparatuses 200 are connected to an external access point AP. In FIG. 3, a communication system 10 including four electronic apparatuses 200-1 to 200-4 as the electronic apparatuses 200 is illustrated. The electronic apparatuses 200-1 to 200-4 are connected to a first access point AP1, which is the external access point AP. In other words, the electronic apparatuses 200-1 to 200-4 have an SSID (Service Set Identifier) and a password and perform connection to the first access point AP1 using the SSID and the password. The SSID includes an ESSID (Extended SSID). The number of the electronic apparatuses 200 connected to the external access point AP is not limited to four. Various modified implementations are possible.

In this state, it is assumed that the first access point AP1 cannot continue operation because of a failure or the like. In this case, the connection between the electronic apparatuses 200-1 to 200-4 and the first access point AP1 is cut off. As a result, for example, the electronic apparatus 200, which is a printer, cannot execute a printing operation through the access point AP. Specifically, the electronic apparatus 200 cannot acquire data for printing from the information processing device connected to the access point AP.

In this case, the user is considered to introduce a second access point AP2 different from the first access point AP1. The electronic apparatuses 200-1 to 200-4 are connected to the second access point AP2, whereby it is possible to execute the printing operation or the like through the access point AP. However, as shown in FIGS. 3 and 4, it is assumed that the first access point AP1 and the second access point AP2 have different SSIDs and different passwords. Accordingly, the plurality of electronic apparatuses 200-1 to 200-4 need to acquire the SSID and the password of the second access point AP2 in order to connect to the second access point AP2. In the following explanation, information for connecting to the access point AP is described as connection information. The connection information is specifically an SSID and a password but may include other information such as a MAC address or an IP address of the access point AP.

In the method of related art such as Patent Literature 1, in a state in which connection to the access point AP before replacement is maintained, transmission and reception of connection information for connecting to a new access point is performed between two apparatuses based on a user instruction. That is, the method of Patent Literature 1 is based on a premise that the access point AP before replacement is functioning. When a failure or the like occurs in the access point AP, the transmission and reception of the connection information cannot be performed.

The electronic apparatus 200 in this embodiment includes the wireless communication section 220 and the processing section 210 as shown in FIG. 2. The wireless communication section 220 performs first wireless communication through the external access point AP and second wireless communication, which is short-range wireless communication. As explained above, the first wireless communication is specifically the wireless communication conforming to the Wi-Fi scheme. The second wireless communication is, for example, the wireless communication conforming to the Bluetooth scheme. The processing section 210 performs communication control for the wireless communication section 220.

When a connection destination by the first wireless communication is switched from the first access point AP1 to the second access point AP2, the processing section 210 performs transmission processing for transmitting connection information for connecting to the second access point AP2 to the other electronic apparatuses 200 using the second wireless communication.

For example, as shown in FIGS. 3 and 4, it is assumed that, after the connection between the electronic apparatuses 200-1 to 200-4 and the first access point AP1 is cut off, the second access point AP2 is set anew and connection between the electronic apparatus 200-1 and the second access point AP2 is performed. In this case, the electronic apparatus 200 in this embodiment is the electronic apparatus 200-1. The electronic apparatuses 200-2 to 200-4 are the other electronic apparatuses. The electronic apparatus 200-1 acquires connection information of the second access point AP2 based on user operation. The electronic apparatus 200-1 transmits the connection information of the second access point AP2 to the electronic apparatuses 200-2 to 200-4 using the second wireless communication. The electronic apparatuses 200-2 to 200-4 connect to the second access point AP2 using the connection information acquired from the electronic apparatus 200-1.

By using the second wireless communication different from the first wireless communication in this way, even when the connection to the connected first access point AP1 is suddenly cut off, it is possible to share the connection information among the plurality of electronic apparatuses 200. The user only has to perform operation for connecting the electronic apparatus 200-1 to the second access point AP2 and does not need to perform connection operation for the other electronic apparatuses 200-2 to 200-4 and the second access point AP2. Accordingly, it is possible to reduce a user burden in replacement of the access point AP.

The method in this embodiment is widely applicable to a situation in which the first access point AP1 cannot be used during the introduction of the second access point AP2. A cause of occurrence of replacement is not limited to the failure of the first access point AP1. For example, when the first access point AP1 is moved to a separated place before the introduction of the second access point AP2, the method in this embodiment can also be applied. The separated place is a place separated so far that at least the electronic apparatus 200 cannot receive a beacon signal from the first access point AP1 at sufficient strength.

The method in this embodiment can be applied to the electronic apparatus 200 explained below. The electronic apparatus 200 includes the wireless communication section 220 and the processing section 210. When the connection to the first access point AP1 by the first wireless communication is cut off, the processing section 210 shifts to a connection standby state. In the connection standby state, when receiving, using the second wireless communication, from another electronic apparatus 200, connection information for connecting to the second access point AP2, the processing section 210 performs connection processing to the second access point AP2 by the first wireless communication using the connection information.

The electronic apparatus 200 is any one of the electronic apparatuses 200-2 to 200-4. The other electronic apparatus 200 is the electronic apparatus 200-1. As shown in FIG. 4, in this embodiment, a given electronic apparatus 200 operates as a master set and performs transmission processing for transmitting connection information and the other electronic apparatus 200 operates as a slave set and performs reception processing for receiving the connection information, whereby the access point AP is replaced. The electronic apparatus 200 in this embodiment may be the electronic apparatus 200 operating as the master set or may be the electronic apparatus 200 operating as the slave set.

The method in this embodiment can be applied to the communication system 10 including the plurality of electronic apparatuses 200. The communication system 10 includes a first electronic apparatus that performs first wireless communication for performing wireless communication through the external access point AP and second wireless communication, which is short-range wireless communication, and a second electronic apparatus that performs the first wireless communication and the second wireless communication. When a connection destination by the first wireless communication is switched from the first access point AP1 to the second access point AP2, the first electronic apparatus performs transmission processing for transmitting connection information for connecting to the second access point AP2 to the second electronic apparatus using the second wireless communication. When the connection to the first access point AP1 by the first wireless communication is cut off, the second electronic apparatus shifts to a connection standby state and performs reception processing for receiving, using the second wireless communication, from the first electronic apparatus, the connection information for connecting to the second access point AP2. The first electronic apparatus is the electronic apparatus 200 operating as the master set and is the electronic apparatus 200-1 in FIG. 4. The second electronic apparatus is the electronic apparatus 200 operating as the slave set and is any one of the electronic apparatuses 200-2 to 200-4 in FIG. 4.

### 2. Flow of Processing

A flow of processing in this embodiment is explained. Specifically, processing before the first access point AP1 fails and processing after the first access point AP1 fails are respectively explained. The processing after the failure includes determination processing for determining whether the first access point AP1 cannot be used and connection processing to the second access point AP2.

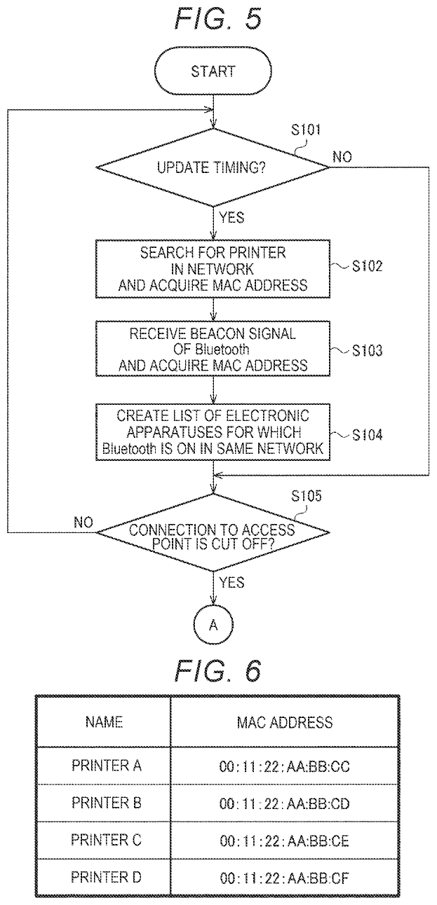

An example in which each of the plurality of electronic apparatuses 200 is capable of executing both of operation of the master set and operation of the slave set is explained with reference to FIGS. 5 to 8. Specifically, when the connection to the first access point AP1 by the first wireless communication is cut off, the processing section 210 executes reception processing for, using the second wireless communication, from another electronic apparatus 200, connection information for connecting to the second access point AP2. The processing section 210 is capable of executing the transmission processing and the reception processing. Which of the transmission processing and the reception processing the processing section 210 executes changes according to a situation. Specifically, the electric apparatus 200 for which connection operation by the user is performed operates as the master set and the other electronic apparatus 200 operates as the slave set.

In this case, the connection operation to the second access point AP2 may be performed in any electronic apparatus 200. Therefore, it is possible to facilitate the connection operation by the user. However, as explained below as a modification, it may be determined in advance as which of the master set and the slave set the electronic apparatuses 200 operate.

FIG. 5 is a flowchart for explaining processing of the electronic apparatus 200 before the first access point AP1 fails. When this processing is started, first, the processing section 210 determines whether processing timing is update timing for list information (step S101). The list information is information for specifying the other electronic apparatuses 200 connected to the first access point AP1. When the processing timing is not the update timing, the processing section 210 skips processing in steps S102 to S104.

When the processing timing is the update timing, the processing section 210 performs processing for searching for the electronic apparatus 200 in a network using the first wireless communication (step S102). The network represents a network formed by the first access point AP1. For example, the electronic apparatus 200 performs processing for designating a broadcast address and transmitting data for presence confirmation. When receiving the data for presence confirmation, the electronic apparatus 200 performs processing for returning data for reply including identification information of the electronic apparatus 200 itself. For example, the storing section 260 of the electronic apparatus 200 stores application software for executing processing in this embodiment including the transmission and reception of the data for presence confirmation and the data for reply. The processing section 210 executes the processing in this embodiment including step S102 by operating according to the application software.

In an example shown in FIGS. 3 and 4, when the electronic apparatus 200-1 performs transmission processing for the data for presence confirmation, each of the electronic apparatuses 200-2 to 200-4 performs return processing for the data for reply. Consequently, the electronic apparatus 200-1 acquires identification information of the electronic apparatuses 200-2 to 200-4, which are the other electronic apparatuses 200, belonging to the same network. Similarly, when the electronic apparatus 200-2 performs the transmission processing for the data for presence confirmation, each of the electronic apparatuses 200-1, 200-3, and 200-4 performs the return processing for the data for reply. Consequently, the electronic apparatus 200-2 acquires identification information of the other electronic apparatuses 200 belonging to the same network. The same applies to the electronic apparatuses 200-3 and 200-4.

Subsequently, the processing section 210 performs transmission and reception of a beacon signal using the second wireless communication. Although not shown in FIG. 5, the second wireless communication section 222 performs processing for periodically transmitting a beacon signal including identification information of the electronic apparatus 200 including the second wireless communication section 222. For example, the beacon signal is transmitted in a state in which a reception terminal is not specified. The beacon signal is received by a reception terminal present within a range. The beacon signal is a signal conforming to the Bluetooth communication standard. Specifically, the beacon signal is an advertise packet used for broadcast of data. When update timings in the plurality of electronic apparatuses 200 are synchronized, the transmission of the beacon signal by the second wireless communication may be performed only at the update timing of the list information.

The second wireless communication section 222 receives beacon signals transmitted by the other electronic apparatuses 200 (step S103). For example, a beacon signal transmitted by the electronic apparatus 200-1 is received by the electronic apparatuses 200-2 to 200-4. The electronic apparatus 200-1 receives beacon signals transmitted by the electronic apparatuses 200-2 to 200-4. The electronic apparatus 200-1 acquires identification information of the electronic apparatuses 200-2 to 200-4 for which the second wireless communication is on. As explained above, the electronic apparatus 200 in this embodiment executes both of the operation of a broadcaster and the operation of an observer.

The processing section 210 creates or updates the list information based on processing results in steps S102 and S103 (step S104). The processing section 210 performs processing for adding, to the list information, the electronic apparatus 200 connected to the first access point AP1 to which the electronic apparatus 200 including the processing section 210 is connected, a function of the second wireless communication being enabled for the electronic apparatus 200.

Specifically, the processing section 210 performs comparison processing for first identification information, which is one or a plurality of kinds of identification information acquired by the processing in step S102, and second identification information, which is one or a plurality of kinds of identification information acquired by the processing in step S103. The processing section 210 adds, to the list information, identification information included in both of the first identification information and the second identification information.

FIG. 6 is an example of the list information. The list information is information including one or a plurality of kinds of identification information included in both of the first identification information and the second identification information. In FIG. 6, an example is shown in which the identification information is a MAC address. However, the identification information may be other information such as an IP address. In FIG. 6, an example is shown in which the list information is information in which the MAC address and a name of the electronic apparatus 200 are associated. However, the name can be omitted.

In the example shown in FIGS. 3 and 4, the electronic apparatus 200-1 creates list information including three MAC addresses corresponding to the electronic apparatuses 200-2 to 200-4. The same applies to the electronic apparatuses 200-2 to 200-4. Each of the electronic apparatuses 200-2 to 200-4 creates list information including MAC addresses of three electronic apparatuses 200 excluding the electronic apparatus 200 itself. Alternatively, the list information may be information including a MAC address of the electronic apparatus 200 itself. In this case, each of the electronic apparatuses 200-1 to 200-4 creates list information including four MAC addresses including a MAC address of the electronic apparatus 200 itself.

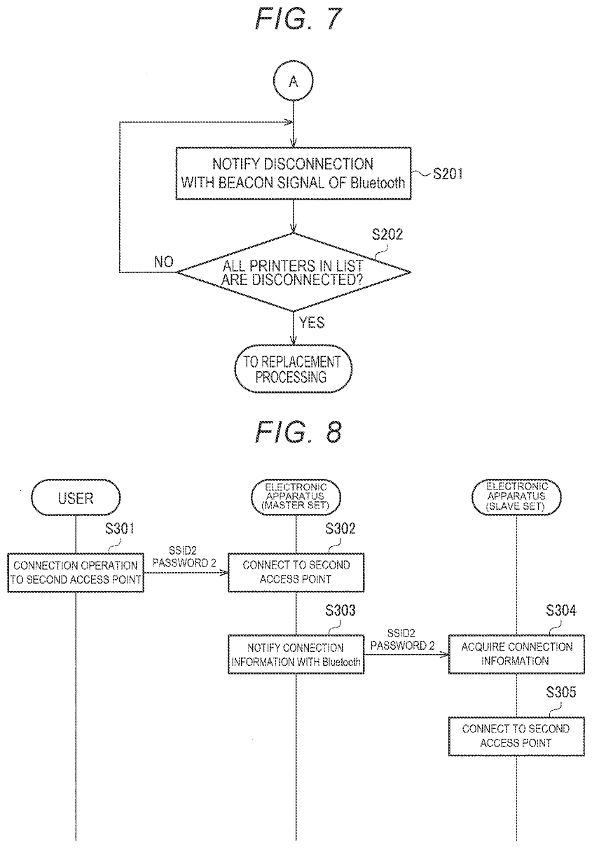

In the case of No in step S101 or after the processing in step S104, the processing section 210 determines whether the connection to the first access point AP1 by the first wireless communication section 221 is cut off (step S105). When the connection is maintained, the processing section 210 returns to step S101 and the processing is continued. That is, when the connection between the first wireless communication section 221 and the first access point AP1 is maintained, the processing section 210 updates the list information by periodically executing the processing in steps S102 to S104. When the connection to the first access point AP1 is cut off, the processing shifts to processing shown in FIG. 7.

FIG. 7 is a flowchart for explaining processing performed when the connection to the first access point AP1 is cut off. When it is determined Yes in step S105 in FIG. 5, the second wireless communication section 222 transmits a beacon signal for notifying the disconnection (step S201). The beacon signal includes information for specifying a transmission source and information indicating that the connection to the access point AP is cut off. For example, a UUID for disconnection notification may be defined as a service UUID.

When the other electronic apparatus 200 is transmitting the beacon signal for disconnection notification, the second wireless communication section 222 receives the beacon signal. The processing section 210 determines, based on a reception result of the beacon signal, about all the electronic apparatuses 200 included in the list information, whether the connection to the first access point AP1 is cut off (step S202).

The processing shown in FIG. 7 corresponds to processing for confirming whether the first access point AP1 is out of order. As shown in FIG. 3, when the first access point AP1 is out of order, all the electronic apparatuses 200 connected to the first access point AP1 are in a disconnected state. Accordingly, each of the electronic apparatuses 200-1 to 200-4 transmits the beacon signal for disconnection notification shown in step S201. As a result, the electronic apparatus 200-1 receives the beacon signal for disconnection notification from each of the electronic apparatuses 200-2 to 200-4. Therefore, it is determined Yes in step S202. The same applies to the electronic apparatuses 200-2 to 200-4. The processing section 210 of each of the electronic apparatuses 200-2 to 200-4 determines Yes in step S202. That is, the determination “Yes” in step S202 is equivalent to high probability that the first access point AP1 is out of order and high necessity of replacing the connection destination of the electronic apparatus 200 included in the list information with a new access point AP. Accordingly, when it is determined Yes in step S202, the processing shifts to processing shown in FIG. 8.

When a deficiency such as a failure occurs in the first wireless communication section 221 of the electronic apparatus 200-1, the connection between the electronic apparatus 200-1 and the first access point AP1 is also cut off. However, in this case, the connection between the other electronic apparatuses 200-2 to 200-4 and the first access point AP1 is maintained. Accordingly, replacement with the second access point AP2 is unnecessary.

Alternatively, in order to change a connection form, it is also conceivable that the user adds the second access point AP2 while maintaining the first access point AP1. For example, after cutting off the connection to the first access point AP1, the user changes a connection destination of the electronic apparatus 200-1 to the second access point AP2. On the other hand, a connection destination of the electronic apparatuses 200-2 to 200-4 is maintained in the first access point AP1. That is, the user sometimes constructs a new network using the second access point AP2 while maintaining a network by the first access point AP1. In this case, it is unpreferable to change the connection destination of the electronic apparatuses 200-2 to 200-4 to the second access point AP2 with connection of the electronic apparatus 200-1 to the second access point AP2 as a trigger.

When the connection between the other electronic apparatuses 200-2 to 200-4 and the first access point AP1 is maintained, these apparatuses do not transmit the beacon signal shown in step S201. As a result, the processing section 210 of the electronic apparatus 200-1 determines No in step S202. In this case, since the processing shown in FIG. 8 is not executed, it is possible to prevent unnecessary replacement processing from being performed.

FIG. 8 is a diagram for explaining a flow of replacement processing for the access point AP. It is assumed that setup operation for the second access point AP2 is performed before the processing shown in FIG. 8.

When this processing is started, first, the user performs operation for causing the electronic apparatus 200-1 to connect to the second access point AP2. Specifically, the user inputs an SSID and a password, which are connection information of the second access point AP2, to the electronic apparatus 200-1 (step S301). The electronic apparatus 200-1 connects to the second access point AP2 using the connection information input by the user (step S302).

Subsequently, the electronic apparatus 200-1 transmits the connection information using the second wireless communication. Since the connection information includes the password, it is unpreferable to transmit and receive the connection information by broadcast. Accordingly, the electronic apparatus 200-1 establishes connection by the second wireless communication to the electronic apparatus 200-2 included in the list information and transmits the connection information using the established connection (S303). Since an example in which the electronic apparatuses 200-2 to 200-4 are registered in the list information is considered, the electronic apparatus 200-1 establishes connection to each of the electronic apparatus 200-3 and the electronic apparatus 200-4 as well and transmits the connection information using the established connection.

For example, the electronic apparatus 200-1 functions as a central apparatus and the electronic apparatuses 200-2 to 200-4 function as peripheral apparatuses. The electronic apparatus 200-1 establishes connection by scanning an advertise packet received from the electronic apparatuses 200-2 to 200-4.

More specifically, when it is determined Yes in step S202 in FIG. 7, the electronic apparatuses 200 shift to a connection standby state. The connection standby state is, for example, a state in which an advertise packet for establishing connection is periodically transmitted. When any one of the electronic apparatuses 200 is connected to the second access point AP2, the electronic apparatus 200 shifts to a state in which scanning of the advertise packet is performed. Consequently, in a scene in which replacement of the access point AP is necessary, it is possible to appropriately establish connection by the second wireless communication. Processing for establishing the second wireless communication is not limited to the above processing. Various modified implementations of the processing are possible. In the second wireless communication such as Bluetooth, various sequences for establishing connection are known and can be widely applied in this embodiment.

The electronic apparatus 200-2 acquires the connection information using the second wireless communication (step S304). The electronic apparatus 200-2 connects to the second access point AP2 based on the acquired connection information (step S305). The same applies to the electronic apparatuses 200-3 and 200-4.

As shown in step S104, in a state in which the electronic apparatus 200 is connected to the first access point AP1 by the first wireless communication, the processing section 210 of the electronic apparatus 200 creates list information for specifying the other electronic apparatuses 200 connected to the first access point AP1. The storing section 260 of the electronic apparatus 200 stores the created list information.

Consequently, when replacement of the access point AP is necessary, it is possible to appropriately specify the electronic apparatuses 200 with which the electronic apparatus 200 shares the connection information. In particular, by using a nonvolatile memory as the storing section 260, it is possible to retain the list information even when a power supply of the electronic apparatus 200 is turned off.

As shown in step S102, the wireless communication section 220 searches for, using the first wireless communication, the other electronic apparatuses 200 connected to the first access point AP1. The processing section 210 causes the storing section 260 to store, as the list information, identification information of the searched other electronic apparatuses 200. The identification information is, for example, MAC addresses.

In this embodiment, a situation in which the first access point AP1 has stopped operating because of a failure or the like is assumed. Therefore, it is desirable to connect apparatuses connected to the first access point AP1 to the second access point AP2 as much as possible. It is unnecessary to extend transmission targets of the connection information to apparatuses connected to the access point AP other than the first access point AP1. By using the connection to the first access point AP1 as a condition for addition to a list, it is possible to appropriately specify the electronic apparatuses 200 set as the transmission targets of the connection information.

As shown in step S103, the wireless communication section 220 may search for, using the second wireless communication, the other electronic apparatuses 200 for which a function of short-range wireless communication is enabled. The processing section 210 causes the storing section 260 to store, as the list information, identification information of the other electronic apparatuses 200 that are connected to the first access point AP1 and for which the function of the short-range wireless communication is enabled.

In this embodiment, the situation in which the first access point AP1 has stopped operating because of a failure or the like is assumed. Therefore, the first wireless communication cannot be used during transmission and reception of the connection information. Accordingly, the electronic apparatus 200 for which the function of the second wireless communication is disabled cannot perform transmission and reception of the connection information. By using the enabled function of the short-range wireless communication as a condition for addition to the list, it is possible to appropriately specify the electronic apparatuses 200 set as the transmission targets of the connection information.

As shown in FIG. 7, the list information is used to determine whether the first access point AP1 has failed. When an apparatus for which the second wireless communication is disabled is likely to be included in the list information, it cannot be distinguished whether a result that a beacon signal for disconnection notification does not reach from the electronic apparatus 200 included in the list information occurs because the connection to the first access point AP1 is maintained or because the second wireless communication is disabled. From the viewpoint of appropriately determining whether the first access point AP1 has failed, it is effective to use the enabled function of the short-range wireless function as the condition for addition to the list information.

In the above explanation, an example is explained in which it is determined using the beacon signal of the second wireless communication whether the function of the second wireless communication is enabled. However, the method in this embodiment is not limited to this. For example, the electronic apparatus 200, which receives the data for presence confirmation with the first wireless communication, may transmit a packet for reply including information indicating whether the second wireless communication of the electronic apparatus 200 itself is enabled or disabled. In this case, the information indicating whether the function of the second wireless communication is enabled can be acquired using the first wireless communication. Therefore, it is possible to omit the processing in step S103 in FIG. 5.

As shown in FIG. 5, the processing section 210 may perform processing for updating the list information at update timing. The update timing may be a high frequency such as every several minutes or may be a power-on time of the electronic apparatus 200. Various modified implementations are possible about specific timing.

Consequently, the list information can be updated as appropriate. Therefore, it is possible to prevent the list information and an actual situation from deviating from each other. The deviation represents, for example, a situation in which there is the electronic apparatus 200 that is described in the list information but does not need to be connected to or cannot be connected to the second access point AP2 because of a cause on the electronic apparatus 200 side. The cause on the electronic apparatus 200 side is a cause, for example, after creation of the latest list information, the electronic apparatus 200 has failed, has been moved to a separated place, or has connected to another access point AP or the function of the second wireless communication has been disabled. When the deviation has occurred, it cannot be distinguished whether a result that a beacon signal for disconnection notification does not reach from the electronic apparatus 200 included in the list information occurs because the connection to the first access point AP1 is maintained or because the cause is present on the electronic apparatus 200 side as explained above. The deviation is suppressed by updating the list information. Therefore, it is possible to appropriately determine whether the first access point AP1 cannot be used.

As shown in FIG. 7, when the connection to the first access point AP1 by the first wireless communication is cut off, the processing section 210 may receive, using the second wireless communication, connection state information from another electronic apparatus 200 specified by the list information and determine, based on a reception result, whether to perform transmission processing for connection information. The connection state information is information representing a connection state between the other electronic apparatus 200 and the first access point AP1 and is, in a narrow sense, information indicating whether the connection to the first access point AP1 is cut off. For example, when a beacon signal in the first wireless communication from the first access point AP1 cannot be received for a predetermined period, the electronic apparatus 200 determines that the connection to the first access point AP1 is cut off.

Consequently, it is possible to appropriately determine whether the first access point AP1 is cannot be used, in other words, whether transmission and reception of the connection information is necessary.

As shown in step S202 in FIG. 7, the processing section 210 may perform the transmission processing on condition that connection between all the other electronic apparatuses 200 specified by the list information and the first access point AP1 is cut off. When the first access point AP1 cannot be used, the electronic apparatus 200 that can maintain the connection to the first access point AP1 is absent. Accordingly, it is possible to appropriately determine a state of the first access point AP1 by adopting the disconnection of all the electronic apparatuses 200 as a condition.

As explained above, the transmission processing and the reception processing are performed by establishing connection of the second wireless communication. For example, the processing section 210 may switch, based on a reception result of the connection state information, whether to execute a sequence necessary for connection establishment. For example, when the electronic apparatus 200, which is a master set, scans an advertise packet received from the electronic apparatus 200, which is a slave set, whereby connection is established, the electronic apparatus 200, which is the slave set, starts transmission of the advertise packet when all the electronic apparatuses 200 are disconnected. The electronic apparatus 200, which is the master set, starts scanning of the advertise packet when the electronic apparatus 200 itself is connected to the second access point AP2 and all the electronic apparatuses 200 are disconnected. However, in the method in this embodiment, the disconnection of all the electronic apparatuses 200 only has to be a condition for replacement to the second access point AP2. Various modified implementations are possible about specific processing.

The processing section 210 performs, using the second wireless communication, transmission processing to another electronic apparatus 200 specified based on the list information. Consequently, it is possible to share the connection information with appropriate electronic apparatus 200. For example, it is possible to prevent transmission omission of the connection information from occurring and prevent the connection information from being transmitted to apparatuses not set as targets of transmission of the connection information.

### 3. Modifications

In the above explanation, an example is explained in which each of the plurality of electronic apparatuses 200 is capable of executing both of the transmission processing of the master set and the reception processing of the slave set. Specifically, the processing shown in FIGS. 5 and 7 is processing common to the plurality of electronic apparatuses 200. In the case of Yes in step S202, the electronic apparatuses 200 shift to the connection standby state. When a given electronic apparatus 200 connects to the second access point AP2, the electronic apparatus 200 establishes connection to the electronic apparatuses 200 in the connection standby state, whereby the connection information is transmitted and received.

However, the method in this embodiment is not limited to this. The given electronic apparatus 200 may be fixed as a master set and the other electronic apparatuses 200 may be fixed as slave sets. For example, when the electronic apparatus 200-1 is the master set and the electronic apparatuses 200-2 to 200-4 are the slave sets, at a replacement time of the access point AP, the user is notified in advance to execute connection operation for the electronic apparatus 200-1 first. When the first access point AP1 has failed, the user connects the electronic apparatus 200-1 to the second access point AP2 according to the notification, whereby the electronic apparatuses 200-2 to 200-4, which are the slave sets, are automatically connected to the second access point AP2. A specific flow of processing is the same as the examples shown in FIGS. 5, 7, and 8.

The method of fixing the master set and the slave sets is particularly useful, for example, when the plurality of electronic apparatuses 200 include devices of different types. For example, the plurality of electronic apparatuses 200 may include a terminal device in addition to the printer. The terminal device may be a portable terminal device such as a smartphone or a tablet terminal or may be an information processing device such as a PC.

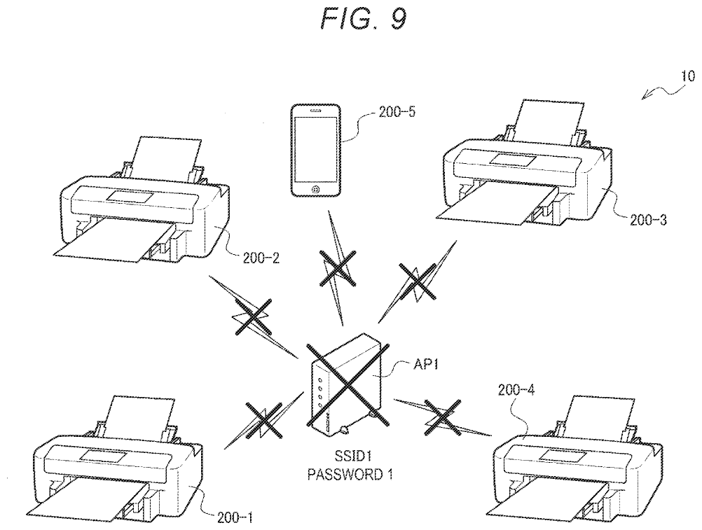

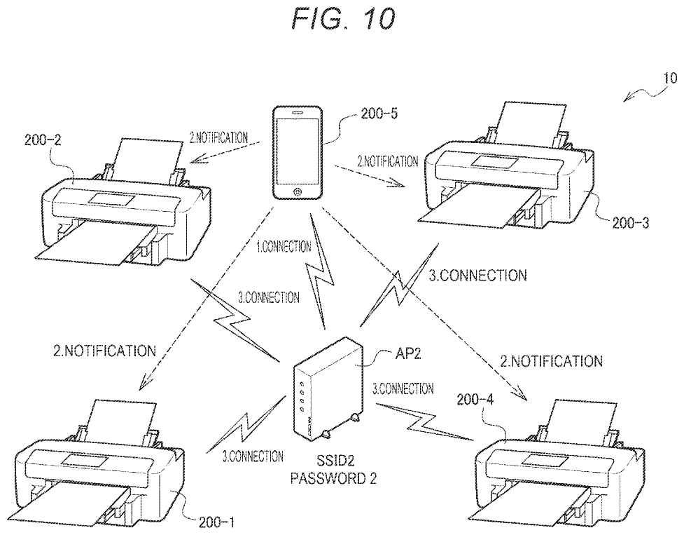

FIGS. 9 and 10 are diagrams for explaining replacement of the access point AP performed when the plurality of electronic apparatuses 200 include the terminal device. FIG. 9 is a diagram showing a state before the replacement. As shown in FIG. 9, the electronic apparatuses 200-1 to 200-4, which are printers, and the electronic apparatus 200-5, which is a terminal device, are provided as the plurality of electronic apparatuses 200. The electronic apparatuses 200-1 to 200-4 and the electronic apparatus 200-5 are connected to the first access point AP1.

The configuration of the electronic apparatus 200-5, which is the terminal device, is the same as the configuration shown in FIG. 2 except that the printing section 250 is omitted. That is, the terminal device includes the processing section 210, the wireless communication section 220, the display section 230, the operation section 240, and the storing section 260. However, the terminal device is not limited to the configuration shown in FIG. 2. Various modified implementations of the configuration are possible, for example, a part of the components are omitted or other components are added.

The printers are connected to the access point AP in order to execute a printing operation through a network. Accordingly, at timing when the printing operation is not executed, a problem is less likely to occur even if the connection to the access point AP is cut off. In contrast, the terminal device is capable of performing operations conforming to various kinds of application software other than a printing application. Application software in recent years often requires connection to a network as represented by an SNS (social networking service). Accordingly, when the first access point AP1 has failed in an environment including the printers and the terminal device, connection priority to the second access point AP2 is considered to be high in the terminal device and low in the printers.

Accordingly, in this case, as shown in FIG. 10, the terminal device functions as the master set and performs transmission processing for connection information of the second access point AP2 and the printers function as the slave sets and perform reception processing for the connection information. Consequently, with an efficient configuration, it is possible to share the connection information among the plurality of electronic apparatuses 200.

The embodiment is explained in detail above. Those skilled in the art will be able to easily understand that many modifications are possible without substantially departing from the new matters and the effects of the embodiment. Therefore, such modifications are assumed to be included in the scope of the present disclosure. For example, a term described together with a different term in a broader sense or a different synonymous term at least once in the specification or the drawings can be replaced with the different term in any part in the specification or the drawings. All combinations of the embodiment and the modifications are also included in the scope of the present disclosure. The configurations, the operations, and the like of the electronic apparatus, the communication system, and the like are not limited to those explained in the embodiment. Various modified implementations of the configurations, the operations, and the like are possible.

What is claimed is:

1. An electronic apparatus comprising:
a wireless communication section configured to perform first wireless communication through an external access point and second wireless communication, which is short-range wireless communication; and
a processing section configured to perform communication control for the wireless communication section, wherein
when a connection destination by the first wireless communication is switched from a first access point to a second access point, the processing section performs transmission processing for transmitting connection information for connecting to the second access point to another electronic apparatus using the second wireless communication.

2. The electronic apparatus according to claim 1, wherein, when connection to the first access point by the first wireless communication is cut off, the processing section executes reception processing for, using the second wireless communication, from the other electronic apparatus, the connection information for connecting to the second access point.

3. The electronic apparatus according to claim 1, further comprising a storing section, wherein
in a state in which the electronic apparatus is connected to the first access point by the first wireless communication, the processing section creates list information for specifying the other electronic apparatus connected to the first access point, and
the storing section stores the created list information.

4. The electronic apparatus according to claim 3, wherein
the wireless communication section searches for, using the first wireless communication, the other electronic apparatus connected to the first access point, and
the processing section causes the storing section to store identification information of the searched other electronic apparatus as the list information.

5. The electronic apparatus according to claim 4, wherein
the wireless communication section searches for, using the second wireless communication, the other electronic apparatus for which a function of the short-range wireless communication is enabled, and
the processing section causes the storing section to store, as the list information, the identification information of the other electronic apparatus that is connected to the first access point and for which the function of the short-range wireless communication is enabled.

6. The electronic apparatus according to claim 3, wherein the processing section performs, using the second wireless communication, the transmission processing to the other electronic apparatus specified based on the list information.

7. The electronic apparatus according to claim 3, wherein the processing section performs processing for updating the list information at update timing.

8. The electronic apparatus according to claim 3, wherein, when the connection to the first access point by the first wireless communication is cut off, the processing section receives, using the second wireless communication, connection state information from the other electronic apparatus specified by the list information and determines, based on a reception result, whether to perform the transmission processing.

9. The electronic apparatus according to claim 8, wherein the processing section performs the transmission processing on condition that it is determined that connection between all the other electronic apparatuses specified by the list information and the first access point is cut off.

10. An electronic apparatus comprising:
a wireless communication section configured to perform first wireless communication through an external access point and second wireless communication, which is short-range wireless communication; and
a processing section configured to perform communication control for the wireless communication section, wherein
the processing section shifts to a connection standby state when connection to a first access point by the first wireless communication is cut off and, in the connection standby state, when receiving, using the second wireless communication, from another electronic apparatus, connection information for connecting to a second access point, performs connection processing to the second access point by the first wireless communication using the connection information.

11. A communication system comprising:
a first electronic apparatus configured to perform first wireless communication for performing wireless communication through an external access point and second wireless communication, which is short-range wireless communication; and
a second electronic apparatus configured to perform the first wireless communication and the second wireless communication, wherein
when a connection destination by the first wireless communication is switched from a first access point to a second access point, the first electronic apparatus performs transmission processing for transmitting connection information for connecting to the second access point to the second electronic apparatus using the second wireless communication, and
the second electronic apparatus shifts to a connection standby state when connection to the first access point by the first wireless communication is cut off and performs reception processing for receiving, using the second wireless communication, from the first electronic apparatus, the connection information for connecting to the second access point.
